(19) United States
(12) Patent Application Publication
(10) Pub. No.: US 2010/0189492 A1
(43) Pub. Date: Jul. 29, 2010

(54) Quick Assembly Desk System And Components Therefor

(75) Inventor: John M. Green, East Otto, NY (US)

Correspondence Address: THE WEBB LAW FIRM, P.C., 700 KOPPERS BUILDING, 436 SEVENTH AVENUE, PITTSBURGH, PA, 15219, US

(73) Assignee: Bush Industries, Inc., Jamestown, NY (US)

(21) Appl. No.: 12/693,653

(22) Filed: Jan. 26, 2010

Related U.S. Application Data
(60) Provisional application No. 61/147,532, filed on Jan. 27, 2009.

(51) Int. Cl. F16B 5/00; F16L 23/00; F16C 11/00; F16B 5/06; A47B 96/00; B23P 21/00

(52) U.S. Cl. 403/71; 403/335; 403/359.6; 403/79; 29/701; 312/352

(57) ABSTRACT

A system for assembling a piece of furniture that includes at least two furniture panel labels affixed to at least two furniture panels. The system also has identifying indicia on each label, the identifying indicia including a designation which identifies the panel to which it is affixed. There is at least one directional indicia on each label, the directional indicia includes a designation which identifies the panel intended to be adjacent to the panel on which the directional indicia are placed. The directional indicia also indicate the relative directional position of the adjacent panel for assembly of the piece of furniture.

### CROSS REFERENCE TO RELATED APPLICATIONS

This application claims the benefit of U.S. Provisional Application 61/147,532 filed Jan. 27, 2009.

### BACKGROUND OF THE INVENTION

1. Field of the Invention

The present invention relates to the construction of furniture, and more particularly, to a system for quick assembly of furniture, such as a desk.

2. Description of Related Art

Furniture can be shipped or purchased in an unassembled state for the user to assemble. Such furniture often includes many panels, the interconnectivity of which can only be ascertained by reference to an assembly manual that includes pictures of the various panels and how they connect to each other. Further, such furniture also typically includes a multitude of connecting and fastening parts that can make it difficult to correctly and quickly assemble the furniture, even once the correct panels have been identified. Further still, users cannot always be sure that the connecting and fastening parts are properly engaged for a secure connection.

### SUMMARY OF THE INVENTION

The present invention addresses these drawbacks by creating a system for assembling furniture that reduces the number of connecting and fastening parts, and also includes a plurality of easy to read and use labels. The system also includes tool-less connectors that make audible clicking noises when the connectors are securely in place.

One embodiment of the subject invention is directed to a system for assembling a piece of furniture made of furniture panels comprising at least two labels. Each label is affixed to a separate furniture panel intended to be attached to another furniture panel. Each label has identifying indicia identifying the panel and directional indicia indicating the identity of the adjacent panel and the relative orientation of the adjacent panel when attached.

A second embodiment of the subject invention is directed to a connector for securing together two panels of a piece of furniture, wherein one panel lies along a first plane and the second panel lies along a second plane which is orthogonal to the first plane. The connector has a mounting plate and an anchoring plate. The mounting plate is adapted to be secured to the first panel and has a knob extending therefrom. The knob has a shank with a length along the knob axis and an associated width. The anchoring plate is adapted to be secured to the second panel and has a base and a connecting portion made up of a cantilevered element extending from the base in a generally orthogonal direction defusing a cantilevered plane. The cantilevered element forms a slot and the width of the slot at an open end and at a closed end is greater than the width of the shank of the knob. Between the ends the slot has a reduced width less than the knob shank width. In the region of the reduced width the cantilevered element includes a secondary slot to form a resilient locking tab. Additionally, the closed end of the slot generally conforms to the shape of the shank of the knob and the tip of the resilient locking tab extends within the slot to define a width equal to or less than the knob shank width. As a result, when the knob moves from the open end to the closed end of the slot, the resilient tab is first depressed and then released to engage and retain the shank of the knob within the closed end of the slot.

Yet another embodiment of the subject invention is directed to a connector for securing together two panels of a piece of furniture, wherein one panel lies along a first plane and the second panel lies along a second plane which is orthogonal to the first plane. The connector has a male component and a female component. The male component has a base with opposing ends and a generally planar face and a T-rail between the ends of the base. The T-rail is defined by a narrow portion connecting a wider portion. The wider portion of the T-rail lies along a plane perpendicular to the base of the male component and the shank of the T-rail lies along an axis parallel to the base of the male component. There is a stabilizing surface adjacent to the T-rail and generally parallel to the base. The female component has a base with opposing ends and a generally planar face and a T-slot between the ends of the base. The wide portion of the T-slot lies along a plane parallel to the base of the female portion and the narrow portion of the T-slot lies along a plane perpendicular to the base. There is a stabilizing surface mounted adjacent to the T-slot and generally parallel to the base. The T-slot of the female component is adapted to receive the T-rail of the male component and the stabilizing surfaces are adapted to abut with one another to provide lateral stability to the paired configuration. A resiliently deflectable tab is mounted along the stabilizing surface of one of either the male component or the female component and a notch extends within the other of the stabilizing surface of the male component or the female component. The deflectable tab is adapted to be received by the notch such that when the two components are mounted, the male component and the female component are retained in the mounted position.

Yet another embodiment of the subject invention is directed to a snap hinge connector for securing two furniture panels at a right angle relative to one another. The snap hinge connector has a hinge pivotable along a hinge axis, a male side, and a female side. The male side is connected to the hinge, wherein the male side has a divider with a recess on one side and a mating face on the other side. The male side has a male side recess along a recess plane adapted to accept a furniture panel. The mating face has resilient tabs extending therefrom, wherein the tabs have a hook configuration with an engaging surface on the interior of the hook. The female side is connected to the hinge, wherein the female side has a divider with a recess on one side and a mating face on the other side. The female side recess along a recess plane is adapted to accept a furniture panel, wherein the mating face has slots extending therein and have rear surfaces adapted to accept the engaging surface. The male mating faces and the female mating surfaces are aligned with one another and come together when the sides are pivoted about the hinge, such that the hook engaging surfaces align with the rear surface of the slots.

Yet another embodiment of the subject invention is directed to a clasp connector for securing together two panels of a piece of furniture, wherein one panel lies along a first plane and the second panel lies along a second plane which is perpendicular to the first plane. The connector has a stud, a sled, and a clasp. The stud is attached to a first panel and has a shank with a shank diameter and a groove therein with a groove diameter. The sled is attached to the second panel and movable along a sled axis, wherein the sled, along the sled axis, has a stud hole adapted to receive the stud shank and an adjacent capture slot having a width less than the width of the stud shank but greater than the width of the groove such that with the stud in the stud hole. When the sled is moved along the sled axis, the capture slot engages the groove and captures the stud. The clasp has a base secured to the second panel proximate to the sled, wherein the clasp has a locking face which acts against a retention groove in a protruding ledge on the sled to maintain the sled in the locked position. These and other features and characteristics of the present invention, as well as the methods of operation and functions of the related elements of structures and the combination of parts and economies of manufacture will become more apparent upon consideration of the following description and the appended claims with reference to the accompanying drawings, all of which form a part of this specification, wherein like reference numerals designate corresponding parts in the various figures. As used in the specification and the claims, the singular form of “a”, “an” and “the” include plural referents unless the context clearly dictates otherwise.

### BRIEF DESCRIPTION OF THE DRAWINGS

FIG. 1 is a front view of a panel label in accordance with the present invention.

FIG. 2 is a perspective view of two connected furniture panels having a panel label attached to each furniture panel.

FIG. 3a is an exploded perspective view of a first embodiment of a system having an anchoring plate and a knobbed element for attaching furniture panels in accordance with the present invention.

FIG. 3b is an exploded perspective view of the system shown in FIG. 3a with the anchoring plate and knobbed element being engaged with each other.

FIG. 4a is a perspective view of the anchoring plate in accordance with the system shown in FIG. 3a.

FIG. 4b is a side elevational view of the anchoring plate shown in FIG. 4a.

FIG. 4c is a close up view of the closed end of the anchoring plate shown in FIG. 4a.

FIG. 5a is a perspective view of a knobbed element in accordance with the system shown in FIG. 3a.

FIG. 5b is a side elevational view of the knobbed element shown in FIG. 5a.

FIG. 6a is an exploded perspective view of a male component and female component of a T-slot assembly in accordance with the present invention.

FIG. 6b is an assembled perspective view of the T-slot assembly shown in FIG. 6a.

FIG. 7a is a front perspective view of the male component of the T-slot assembly in accordance with the present invention.

FIG. 7b is a rear perspective view of the male component of the T-slot assembly shown in FIG. 7a.

FIG. 7c is a front elevational view of the male component of the T-slot assembly shown in FIG. 7a.

FIG. 7d is a side elevational view of the male component of the T-slot assembly shown in FIG. 7a.

FIG. 7e is a side cross-sectional view of the male component of the T-slot assembly taken along line A-A in FIG. 7c and looking in the direction indicated with the “A” arrows in FIG. 7c.

FIG. 8 is an exploded perspective view of the male and female components of the T-slot assembly in accordance with the present invention.

FIG. 9a is a perspective view of a snap hinge in accordance with the present invention in an opened position.

FIG. 9b is a top plan view of the snap hinge shown in FIG. 9a.

FIG. 9c is a front plan view of the snap hinge shown in FIG. 9a.

FIG. 10 is a perspective view of the snap hinge shown in FIG. 9a, with two drawer panels attached thereto.

FIG. 11a is a perspective view of a drawer being assembled using the snap hinge shown in FIG. 9a.

FIG. 11b is a perspective view of the drawer shown in FIG. 11a with the drawer being further assembled.

FIGS. 12a-d are perspective views of a clasp connector system overview shown in sequential stages of its clasping operation.

FIGS. 13a-c are perspective views of the clasp connector system shown in FIG. 12 shown in sequential stages of its operation.

FIG. 14a is a perspective view of a stud in the clasp connector system shown in FIGS. 12 and 13.

FIG. 14b is a front elevational view of the stud shown in FIG. 14a.

FIG. 15a is a perspective view of a sled in the clasp connector system shown in FIGS. 12 and 13.

FIG. 15b is a front elevational view of the sled shown in FIG. 15a.

FIG. 15c is a side elevational view of the sled shown in FIG. 15a.

FIG. 16a is a front perspective view of a clasping element in the clasp connector system shown in FIGS. 12 and 13.

FIG. 16b is a rear perspective view of the clasping element shown in FIG. 16a.

FIG. 16c is a front view of the clasping element shown in FIG. 16a.

FIG. 16d is a rear view of the clasping element shown in FIG. 16a.

FIG. 16e is a side view of the clasping element shown in FIG. 16a.

FIG. 16f is a side cross-sectional view of the clasping element taken along line A-A in FIG. 16d.

### DESCRIPTION OF THE PREFERRED EMBODIMENTS

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume multiple alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

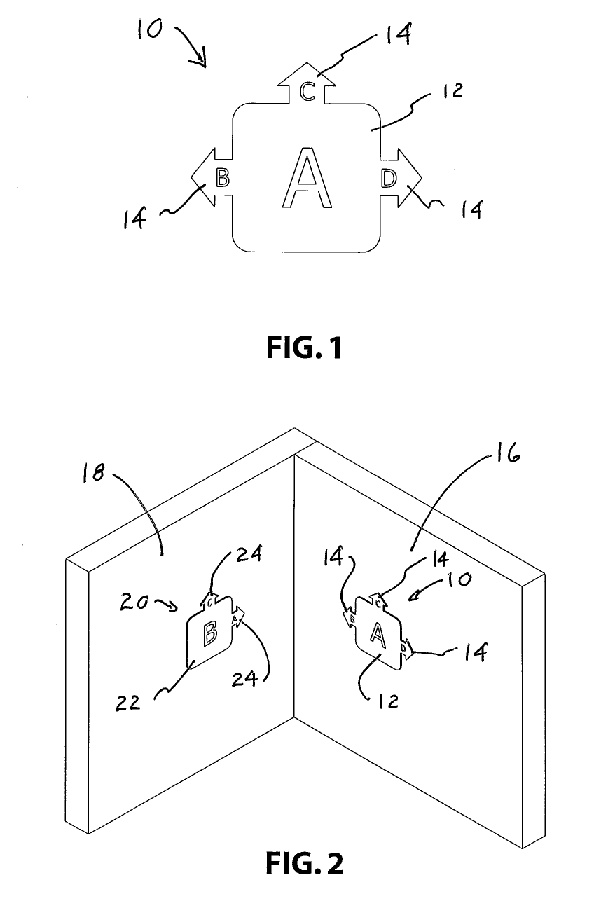

The present invention is directed to a system for assembling furniture that includes a plurality of panel labels. FIG. 1 shows a panel label 10. The panel label 10 illustrated is a sticker that is configured to be affixed to a panel of furniture via an adhesive back side or affixed in any other manner known in the art, although it may be painted or printed onto a furniture panel. The panel label may be made of any suitable material such as paper or plastic. The panel label 10 shown in FIG. 1 includes identifying indicia 12 and three directional indices 14. Although three directional indices 14 are illustrated, there can be as few as one. The directional indices 14 have arrow shapes to point in various directions with respect to the identifying indicia 12. The identifying indicia 12 have a designation “A” printed on it, while the directional indices 14 include designations “B,” “C,” and “D.” The letter designation on the identifying indicia 12 corresponds to the furniture panel on which the panel label 10 is affixed. The letter designations on the directional indices 14 correspond to furniture panels that are designed to be adjacent to the furniture panel associated with the identifying indicia 12 when the piece of furniture is assembled. While the panel label 10 shown in FIG. 1 has only letter designations, other designations such as numbers, symbols, or names may also be used.

As illustrated in FIG. 1, the identifying indicia 12 are positioned at the core of the label 10. Additionally, the directional indicia 14 are positioned about the periphery of the label 10.

FIG. 2 is helpful to clarify the usage of such panel labels. FIG. 2 shows a first furniture panel 16 and a second furniture panel 18 attached to each other. The first furniture panel 16 has the panel label 10 shown in FIG. 1 affixed to it. The second furniture panel 18 has an adjacent panel label 20 affixed to it. The adjacent panel label 20 has an identifying indicia 22 marked with designation “B” and directional indices 24 marked with designations “A” and “C.” With the panel labels 10, 20 affixed to the furniture panels 16, 18, the respective identifying indices 12, 22 of the panel labels 10, 20 associate the first furniture panel 16 with the letter “A” and the second furniture panel 18 with the letter “B.” The arrow shapes of the directional indices 14, 24 point in the direction of the associated adjacent furniture panels. The directional indicia 14 designated “B” on panel label 10 indicates that the furniture panel adjacent to the first furniture panel 16 is the panel associated with letter “B”, namely the second furniture panel 18. Because the directional indicia 14 designated “B” is in an arrow shape, it further indicates that the second furniture panel 18 will be to the left of the first furniture panel 16, as viewed in FIG. 2. Likewise, the directional indicia 24 designated “A” on panel label 20 indicates that the furniture panel adjacent to the second furniture panel 18 is the panel associated with the letter “A,” namely the first furniture panel 16. Again, because the directional indicia 24 designated “A” is in an arrow shape, it further indicates that the first furniture panel 16 will be to the right of the second furniture panel 18, as viewed in FIG. 2.

Further, panel label 10 and panel label 20 both include directional indices 14, 24 designated “C” pointing upward. This indicates that a third furniture panel associated with the letter “C” (not shown in FIG. 2) is to be attached to the top of both the first and second furniture panels 16, 18. Panel label 10 also includes a directional indicia 14 designated “D,” indicating that a fourth furniture panel associated with the letter “D” (not shown in FIG. 2) is the be attached to the right of the first furniture panel 16. Thus, when assembling a piece of furniture having panel labels 10 and 20, the assembler can consult the panel labels to determine which furniture panels are adjacent to each other and attach them accordingly.

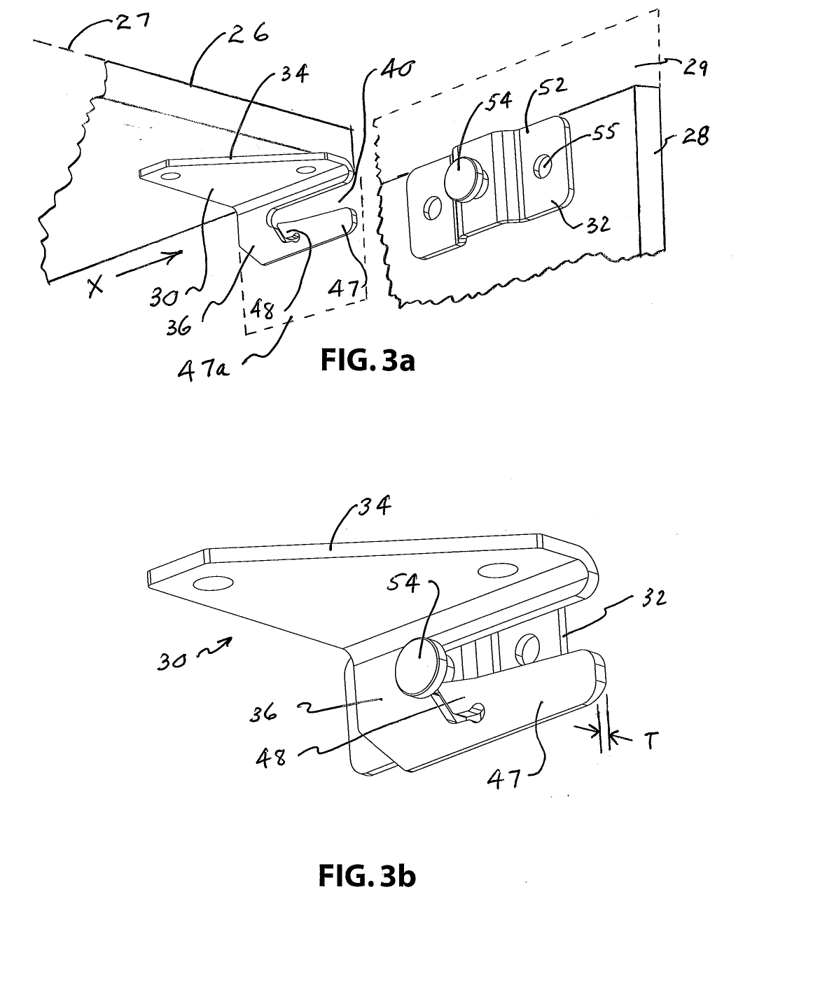

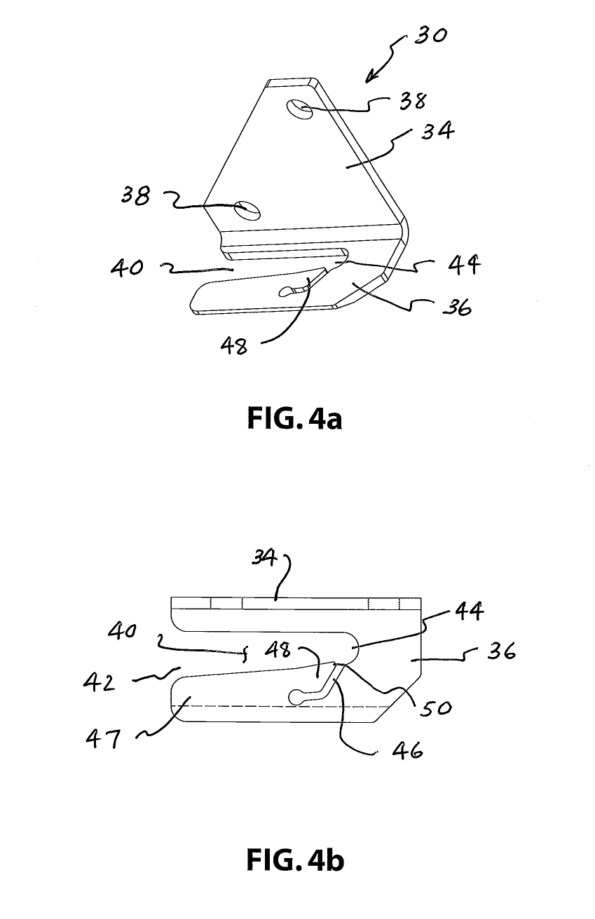

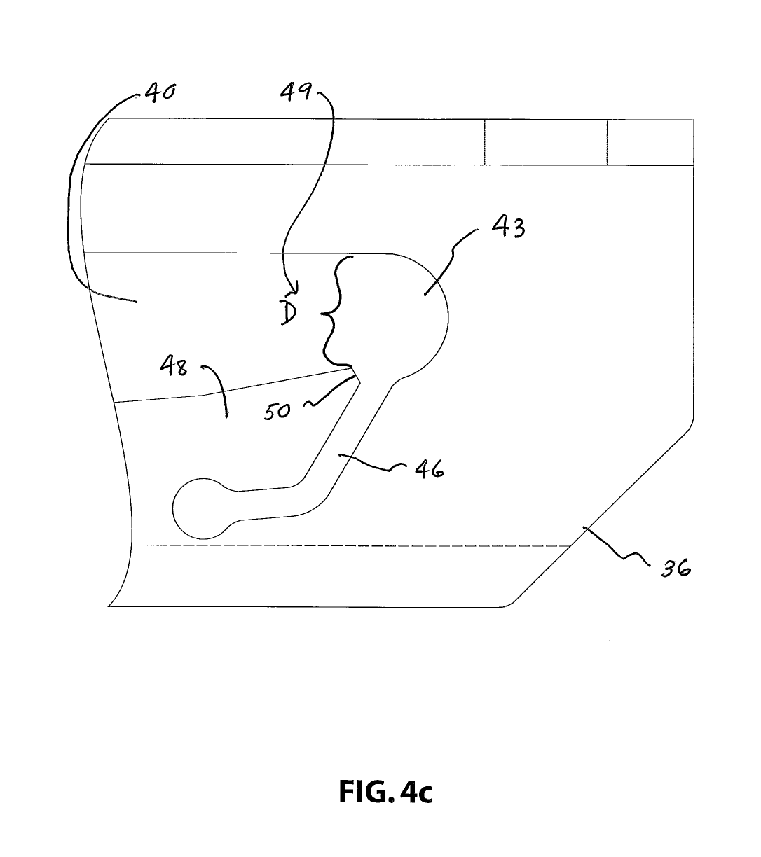

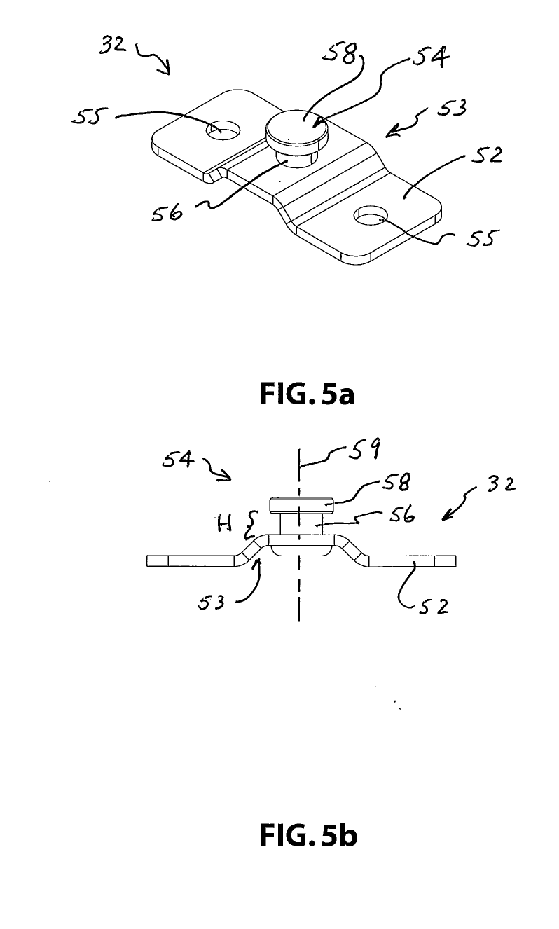

The present invention is also directed to a system for securing together two panels 26, 28 of a piece of furniture, wherein one panel 26 lies along a first plane 27 and the second panel 28 lies along a second plane 29, which is orthogonal to the first plane 27. In a first embodiment of the system shown in FIGS. 3a and 3b, the system includes an anchoring plate 30 and a knobbed element 32. As shown in FIGS. 3a-b and 4a-c, the anchoring plate 30 includes a base 34 and a connecting portion 36. The base 34 is substantially planar and may be attached to a furniture panel with screws through holes 38 that extend through the base 34, or by any other means known in the art to anchor the anchoring plate 30 to a furniture panel. The connecting portion 36 of the anchoring plate 30 is also substantially planar and extends orthogonally downward from the base 34. The connecting portion 36 includes a slot 40 having length L (FIG. 4b) and defining an open end 42 and a closed end 44. As shown in FIG. 4b, the slot 40 generally reduces in width along its length L from the open end 42 to the closed end 44, which has a curved shape. The closed end 44 of the slot 40 generally conforms to the shape of the shank 56 of the knob 54 (FIG. 5b). While the shape of the closed end 44 is illustrated as being curved to define an arc along a circle, the closed end 44 may be configured in various other shapes as long as the closed end 44 is adapted to receive and capture the knobbed element 32 as described below. As shown in FIGS. 4b and 4c, the closed end 44 has a passage 46, whereby material of the connecting portion 36 is absent and produces a cantilevered element 47 with a tab 48. The cantilevered element 47 extends from the base 34 in a generally orthogonal direction defining a cantilevered plane 47a. The tab 48 has a tip 50 having a concave arc shape that lies along the same arc defined by the closed end 44 of the slot 40. Distance D, the width of the slot 40 at the tip 50 of the tab 48 shown in FIG. 4c defining gap 49, is less than that of the width of the closed end 44 of the slot 40. As a result, the width of the slot 40 at the open end 42 and at the closed end 44 is greater than the width of the shank 56 of the knob 54. Also, between the ends 42, 44 the slot 40 has a reduced width less than the width of the knob shank 56.

As shown in FIGS. 5a and 5b, the knobbed element, or mounting plate, 32 has a knob 54 extending from a base 52 that is substantially planar, but has a raised portion 53 at its center where the knob 54 is attached. The base 52 may be attached to a furniture panel by using screws through holes 55 that exist at the opposite ends of the base 52, or by any other method known in the art. The knob 54 includes a lower portion, or shank, 56 and an upper portion, or enlarged end, 58. Both the lower portion 56 and upper portion 58 are substantially cylindrical, with the diameter of the upper portion 58 being larger than that of the lower portion 56. The diameter of the lower portion 56 is the same as that of the circle defined by the closed end 44 of the slot 40 on the anchoring plate 30. The height H (FIG. 5b) of the lower portion 56 of the knob 54 is adapted to approximately equal the thickness T (shown in FIG. 3b) of the connecting portion 36 of the anchoring plate 30, such that the knob 54 can engage snugly with the slot 40.

Referring now to FIGS. 3a and 3b, in operation the anchoring plate 30 and knobbed element 32 would each be attached to separate furniture panels as described above. The anchoring plate 30 would move in direction X (shown in FIG. 3a) relative to the knobbed element 32. As the lower portion 56 of the knob 54 moves into the slot 40 toward the closed end 44, it would eventually reach the tab 48. Referring now also to FIG. 4c, because distance D of the gap 49 is less than that of the diameter of the lower portion 56 (FIG. 5a) of the knob 54, the knob 54 will meet resistance once it reaches the tab 48 because it cannot fit past the gap 49. As the knob 54 is further pushed toward the closed end 44 of the slot 40, the tab 48 will deflect both downward into the passage 46 and laterally out of the plane in which the connecting portion 36 exists. For this reason, the anchoring plate 30 is constructed of a material such as plastic that is suitably resilient. As the tab 48 deflects in this manner while the knob 54 moves toward the closed end 44 of the slot 40, the distance D of the gap 49 will grow until it is equal to the diameter of the lower portion 56 of the knob 54. At that point, the knob 54 will pass over the tab 48 and settle into the closed end 44 of the slot 40, allowing the tab 48 to then snap back toward its original configuration, resulting in an audible clicking sound. The tab 48 need not return to its precise original location, but must only substantially return to its undeflected position to secure the knobbed element 32 to the anchoring plate 30. This click alerts the user that the slotted and knobbed elements 30 and 32 are properly engaged and connected. The knob 54 would then be securely captured in place by virtue of the lower portion 56 of the knob 54 having the same diameter as the circle formed by the closed end 44 of the slot 40 and the tip 50 of the tab 48. An attempt to remove the knobbed element 32 from the anchoring plate 30 by pulling it in the opposite direction of direction X will be resisted by the tip 50 of the tab 48. Further, because the upper portion 58 of the knob 54 has a greater diameter than that of the lower portion 56, the upper portion 58 prevents the anchoring plate 30 from being removed in a direction laterally out of the plane in which the connecting portion 36 of the anchoring plate 30 exists. In other words, the knob 54, when captured in the closed end 44 of the slot 40, is retained along the length of the slot 40 and also retained in a direction along the axis 59 of the knob shank 56. Once the knobbed element 32 is inserted into the anchoring plate 30, the system would then appear as it is shown in FIG. 3b.

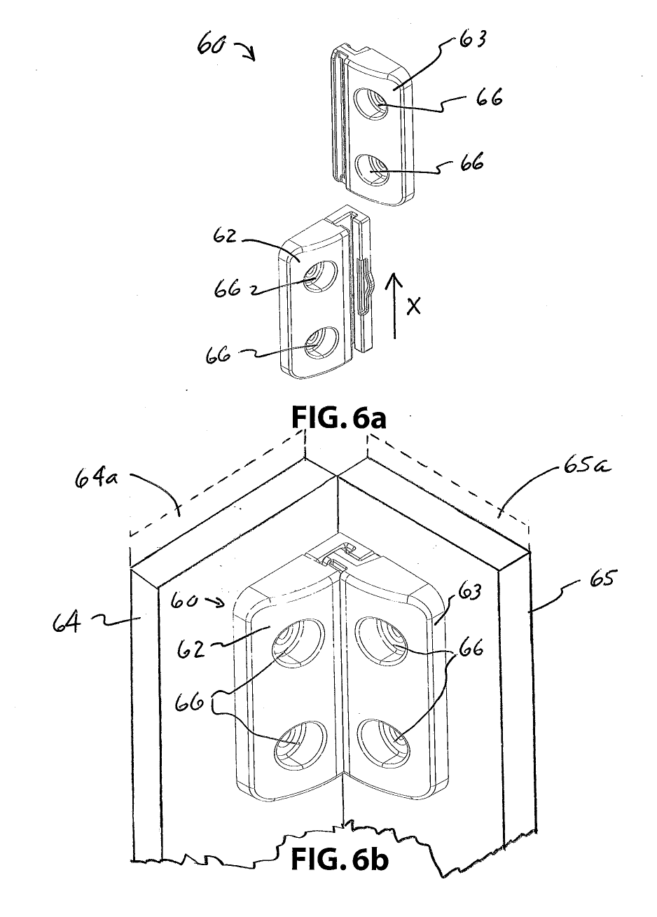

Another embodiment of the present invention is a T-slot assembly. As shown in FIGS. 6a-b, the T-slot assembly 60 has a male component 62 and a female component 63 that interlock for securing two panels 64, 65 of a piece of furniture, wherein one panel 64 lies along a first plane 64a and the second panel 65 lies along a second plane 65a, which is orthogonal to the first plane 64a.

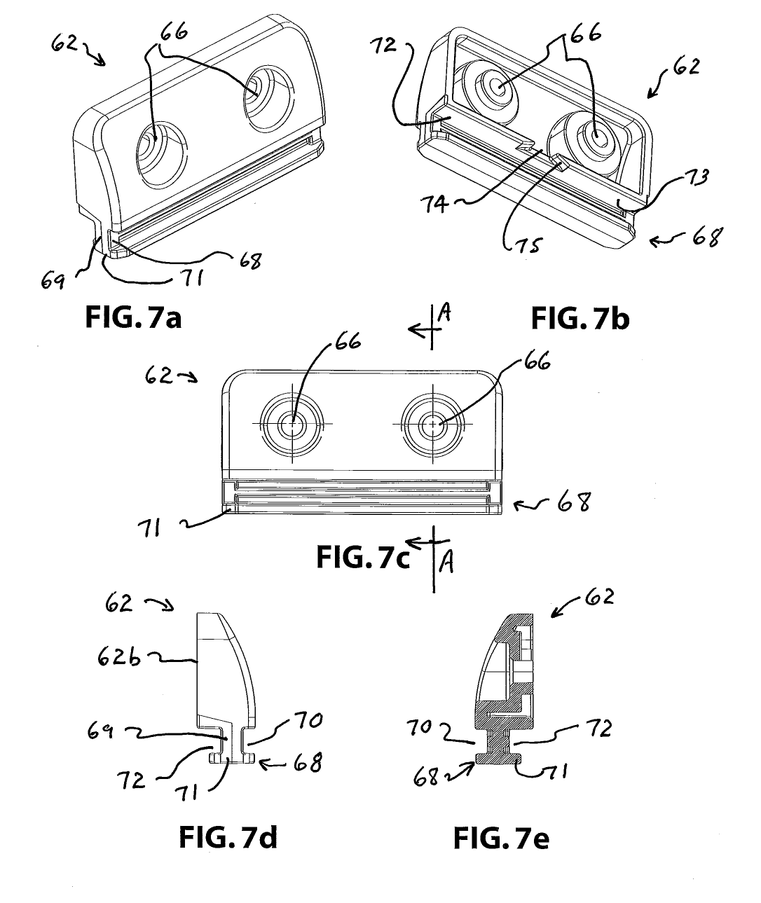

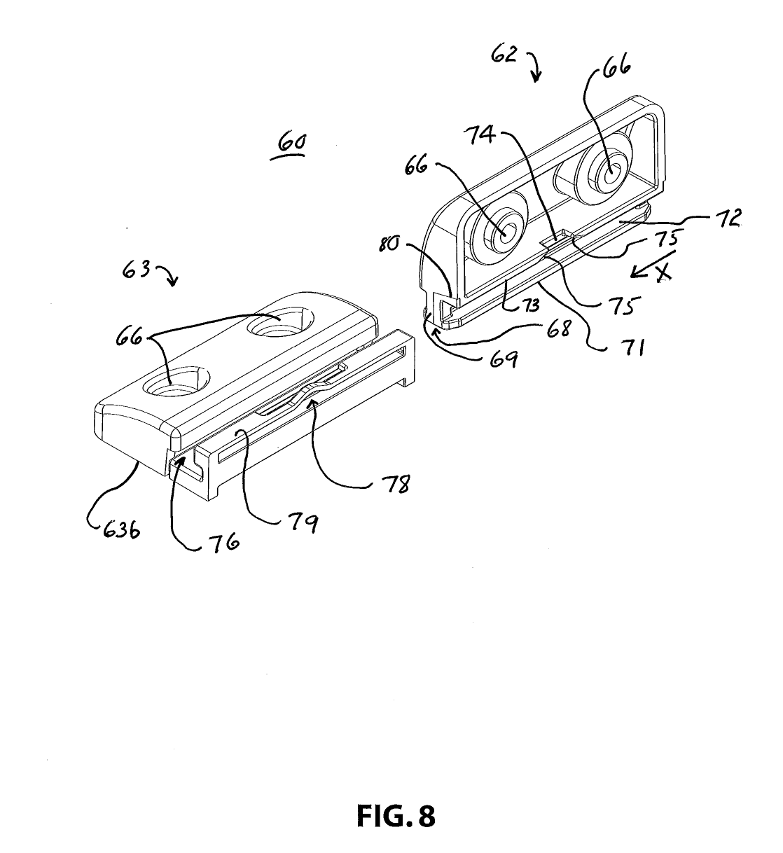

The male and female components 62 and 63 each have contoured front surfaces and substantially flat back surfaces, or bases 62b, 63b (as shown in side view FIG. 8) and include holes 66 extending though the front and back surfaces of the components 62, 63. The components 62 and 63 may be attached to furniture panels via nails or screws through holes 66, or by any other means of attachment known in the art. Referring now to FIGS. 7a-e, at the bottom of the male component 62 is a T-rail 68 running lengthwise along the male component 62. The T-rail 68 is defined by a narrow portion, or shank, 69 made up of a front channel 70 and rear channel 72, with an end, or wider portion, 71 to form a “T” shape. The wider portion 71 lies along a plane perpendicular to the base 62b of the male component 62 and the shank 69 lies along the axis parallel to the base 62b of the male component 62. As shown in FIG. 7b, on the upper surface 73 of the male component 62 defined by the rear channel 72 is a notch 74 recessed within the upper surface 73. Upper surface 73 interacts with a matching portion of the female component 63 and acts as a stabilizing surface. The stabilizing surface 73 is generally perpendicular to the base 62b and is generally planar.

FIG. 8 shows a female component 63 of the T-slot assembly 60. The female component 63 includes a T-slot 76 adapted to receive the T-rail 68 of the male component 62. The T-slot 76 is defined by an internal channel through the bottom portion of the female component 63. The internal channel has the same shape as the external shape of the T-rail 68 such that the T-rail 68 can slide into the T-slot 76 by moving the male component 62 in direction X relative to the female component 63, as shown in FIGS. 8 and 6a. Generally conforming to the shape of the stabilizing surface 73 on the male component 62, the female component 63 also has a stabilizing surface 79 adjacent to the T-slot 76 and generally parallel to the base 63b. The stabilizing surface 79 is also generally planar. The female component 63 also has a resilient deflectable tab 78 formed in a substantially arch-shaped configuration extending outward from front exterior surface 79 of the T-slot 76. The tab 78 is sized and configured to fit into the notch 74 on the male component 62. The tab 78 is adapted to be flexible such that it can be pressed downward to become substantially flush with the front exterior surface 79 of the T-slot 76, but will spring back toward its original configuration shown in FIG. 8. For this reason, the female component 63, or at least the tab 78, should be made of a suitably strong, yet flexible material such as plastic.

Referring to FIG. 8, in operation, the male component 62 moves in direction X such that the T-rail 68 of the male component 62 slides into the T-slot 76 of the female component 63. As the tab 78 reaches the rear channel 72 of the male component 62 and is continued to be pushed, the tab 78 is deflected against the upper surface 73. This deflection of the tab 78 occurs because leading edge 80 of the upper surface 73, defined by the rear channel 72 of the male component 62, rides up the arch-shaped tab 78 and presses the tab 78 downward as the male component 62 slides along the female component 63. With the tab 78 depressed by the upper surface 73 defined by the rear channel 72, the T-rail 68 slides along the T-slot 76 until the tab 78 reaches the notch 74. At that point, the tab 78, no longer being held down by the upper surface 73 defined by the rear channel 72, snaps substantially back into its original arch-shaped configuration and engages the notch 74. The tab 78 engaging with the notch 74 in this manner results in an audible clicking noise. This click alerts that user that the male and female components 62, 63 are properly engaged and connected. At this point, the T-slot assembly 60 appears as shown in FIG. 6b.

Once the male and female components 62, 63 are so engaged, the components are securely held in that configuration by virtue of the tab 78 being disposed within the notch 74. This is because it requires downward pressure on the tab 78 to make the tab 78 again flush with the upper surface 73 defined by the rear channel 72 so that the components 62, 63 may again slide in direction X relative to each other. Such downward pressure on the tab 78 can be attained by forcing either the male or female components 62, 63 in direction X to cause side walls 75 (FIGS. 7b and 8), defined by notch 74, to press down the tab 78, but it is desirable to configure the shape, size, and flexibility of the tab 78 and notch 74, such that the male and female components 62, 63 do not disengage unless intended by the user of the T-slot assembly 60.

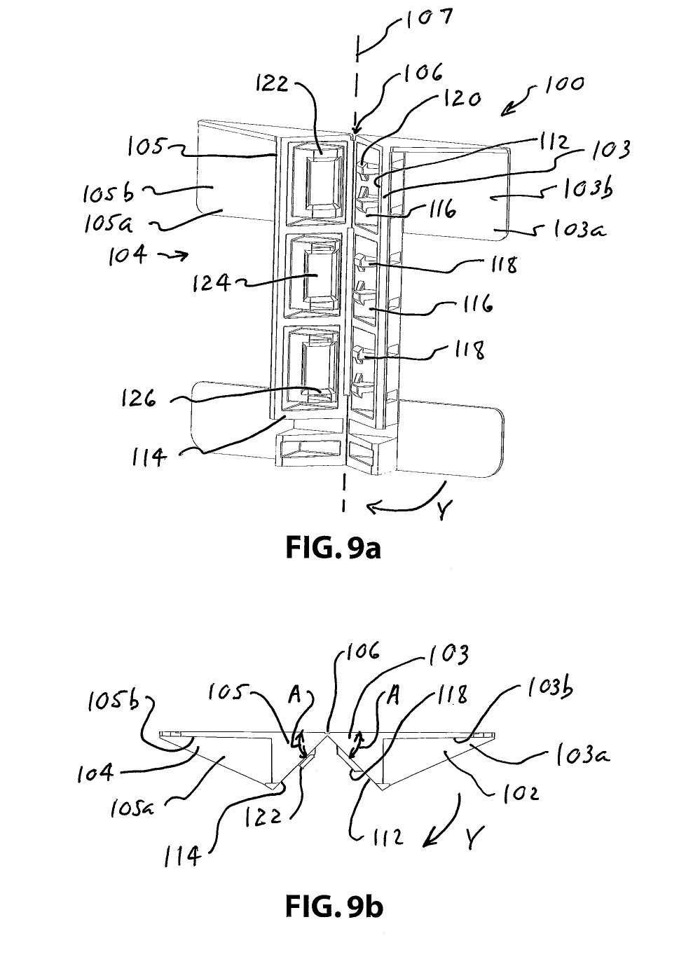

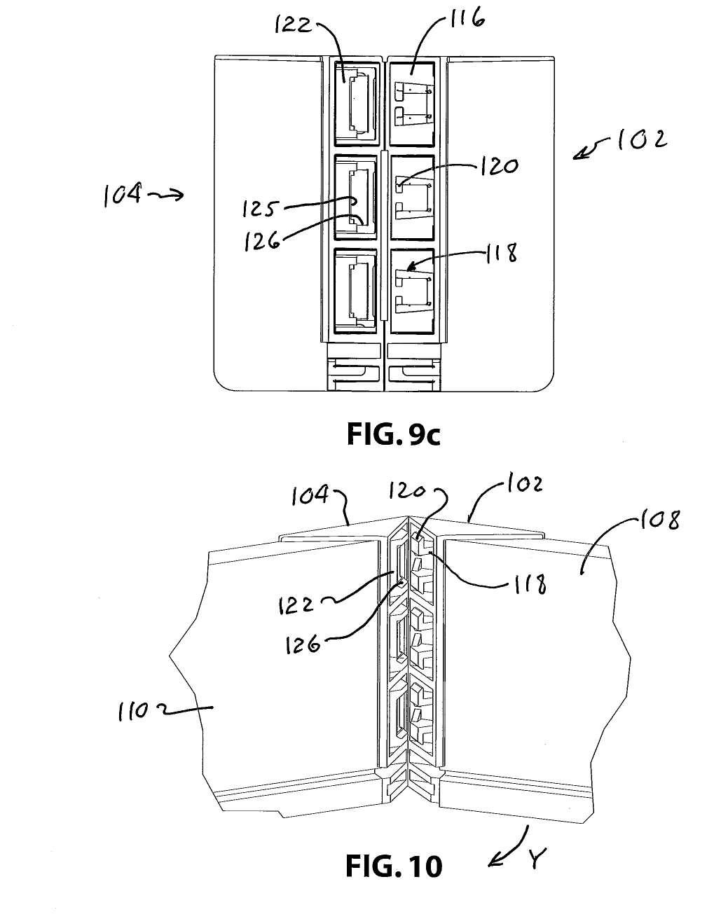

Another embodiment of the present invention is a snap hinge connector 100, as shown in FIGS. 9a-c. The snap hinge connector 100 includes a male side 102 and a female side 104. The male side 102 and female side 104 are each shaped generally like a triangular prism and are adjacently joined at points on their respective triangular edges by a hinge 106 (see top view in FIG. 9b) pivotable about a hinge axis 107 (FIG. 9a). The snap hinge connector 100 may be made of any suitably resilient but stiff material such as plastic. As shown in FIG. 9b, the hinge 106 may likewise be constructed of a thin portion of plastic to make the hinge 106 flexible so that the male side 102 and female side 104 may be bent with respect to the hinge 106. In this way, the male and female sides 102, 104 and hinge 106 may be collectively constructed of a single piece of plastic. The male side 102 has a divider 103 with a recess 103a on one side and a mating face 112 on the other side. The recess 103a lies along a recess plane 103b and is adapted to accept a furniture panel 108 (FIG. 10).

The female side 104 has a divider 105 with a recess 105a on one side and a mating face 114 on the other side. The recess 105a lies along a recess plane 105b and is adapted to accept a furniture panel 110. The furniture panels 108, 110 may be attached to the male and female sides 102, 104 of the snap hinge connector 100 by any means known in the art.

Referring to FIGS. 9b and 10, the male side 102 of the snap hinge connector 100 has a male mating face 112 and the female side 104 has a female mating face 114, each face disposed adjacent to the other with the hinge 106 in between them. The male mating face 112 includes at least one cavity 116 having at least one resilient deflectable hook-shaped tab 118 extending outwardly from the cavity 116. The tabs 118 are protruding and have an end that includes a ramp 120 defined by a beveled surface of the tab 118. The female mating face 114 includes at least one rectangular mound 122 extending outwardly from the female mating face 114 and defining slots 124 therein. Each slot 124 may include a beveled surface 126 around its inner perimeter sloping inward toward the slot 124. The ramp 120 and beveled surface 126 are inversely sized and configured such that when the male side 102 of the snap hinge connector 100 is rotated in direction Y (FIGS. 9a-b and 10), the surface of the ramp 120 will engage with the surface of the beveled surface 126, such that the respective surfaces are in direct contact, adjacent to each other.

In operation, the male side 102 is rotated in direction Y with respect to the female side 104 of the snap hinge connector 100. The ramps 120 of the tabs 118 come into engagement with the beveled surfaces 126 of the mounds 122 as described above. At this point, continued pressure is applied to the male side 102 to push it further in direction Y, putting pressure on the ramps 120 and causing them to deflect inward toward the slots 124 on the female side 104. Eventually, as the male side 102 continues to rotate, the tabs 118 will deflect enough to slip past the beveled surfaces 126 of the mounds 122 and into the slots 124. At this point, the tabs 118 snap substantially back into their original configuration resulting in an audible clicking sound due to the tabs 118 striking the mounds 122. The hook-shaped tabs 118 are then gripping the rear surfaces 125 of the slots 124 so that the tabs 118 cannot slip back out of the slots 124 by rotating the male side 102 in a direction opposite to that of direction Y. The tabs 118 deflect in a direction parallel to the hinge axis 107 and the slot rear surfaces 125 are parallel with the hinge axis 107 to accept and engage the tabs 118. The tabs 118 should be constructed of a rigid yet flexible material, such as plastic, in order to deflect in the manner described herein. As illustrated, there are a multiple tab/slot pairs along the length of the hinge 106. Additionally, there are two tabs 118 associated with each slot 124.

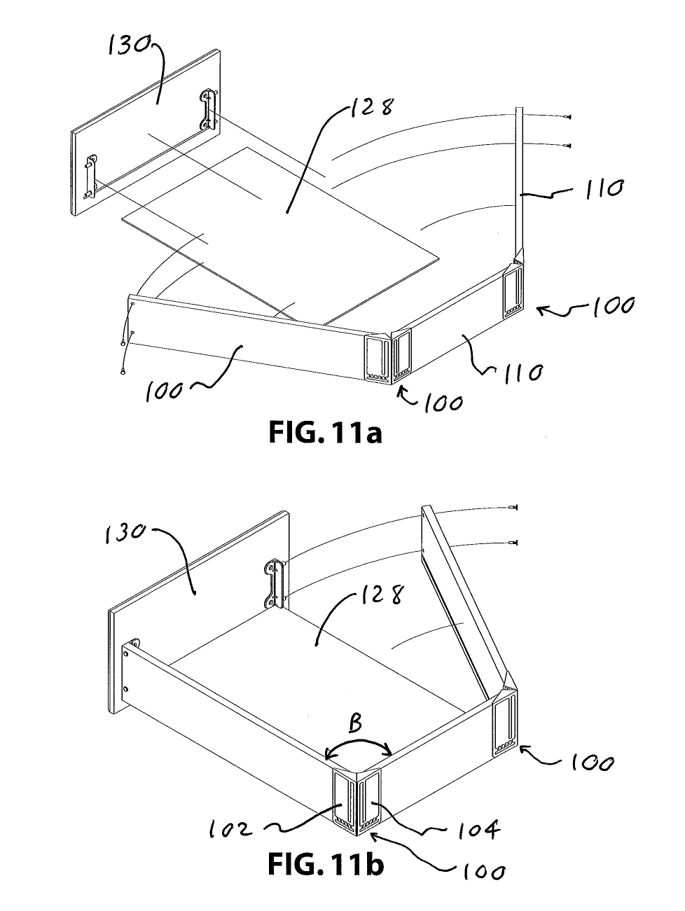

In this closed position, the male and female mating faces 112, 114 are flush with each other and the mounds 122 of the female mating face 113 are disposed within the cavities 116 on the male side 102. The snap hinge connector 100 and drawer panels 110 may be sized and configured such that the drawer panels 110 form a right angle when the snap hinge connector 100 is in this closed position as shown in FIG. 11b. FIGS. 11a and 11b show how the snap hinge connector 100 may be used to assemble drawer panel 110, a drawer bottom 128, and a drawer front 130 to form a drawer.

As illustrated in FIG. 9b, the mating faces 112, 114 form an angle A of 45 degrees with the respective recess plane 103b, 105b, such that when the mating faces 112, 114 contact one another, the recess planes 103b, 105b form an angle B of 90 degrees with one another, as illustrated in FIG. 11b.

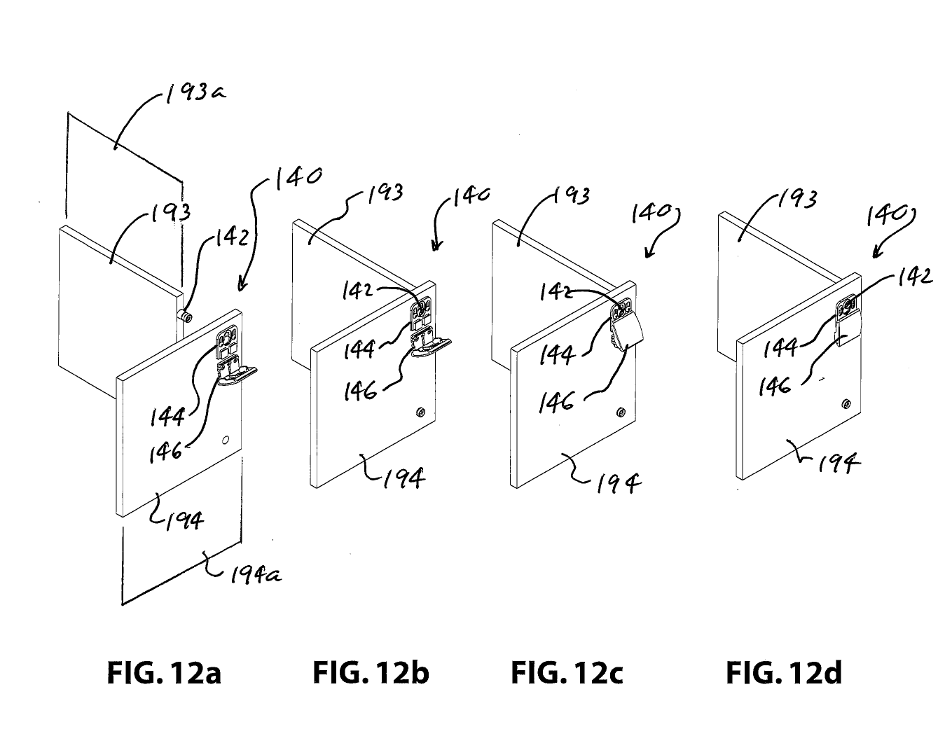

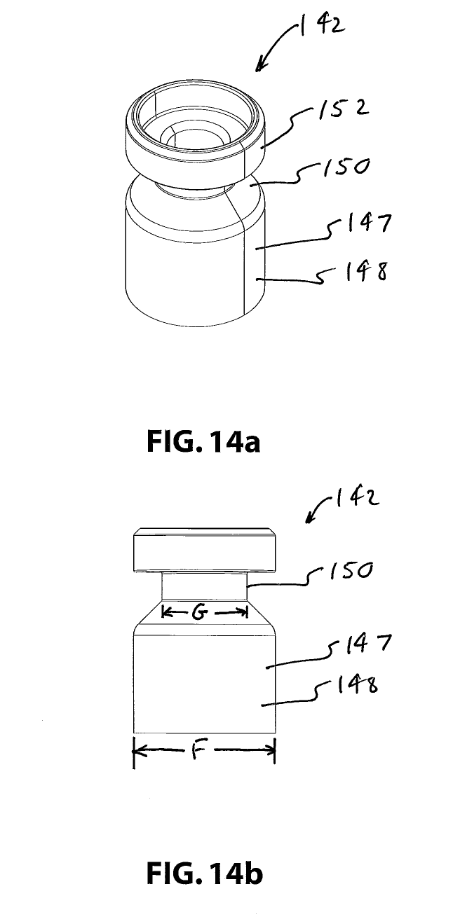

Another aspect of the present invention is a clasp connector system 140, shown in FIGS. 12a-d and 13a-c. The clasp connector system 140 includes a stud 142, a sled 144, and a clasp 146. As shown in FIGS. 14a-b, the stud 142 is generally cylindrically shaped and includes a shank 147 having a lower portion 148, a middle portion 150, and an upper portion 152. The lower portion 148 and upper portion 152 have the same diameter F, while the middle portion 150 has a diameter G less than that of diameter F. At the interface between the lower portion 148 and middle portion 150, the diameter F tapers to reduce to diameter G. At the interface between the middle portion 150 and the upper portion 152, the diameter abruptly changes from diameter G to diameter F.

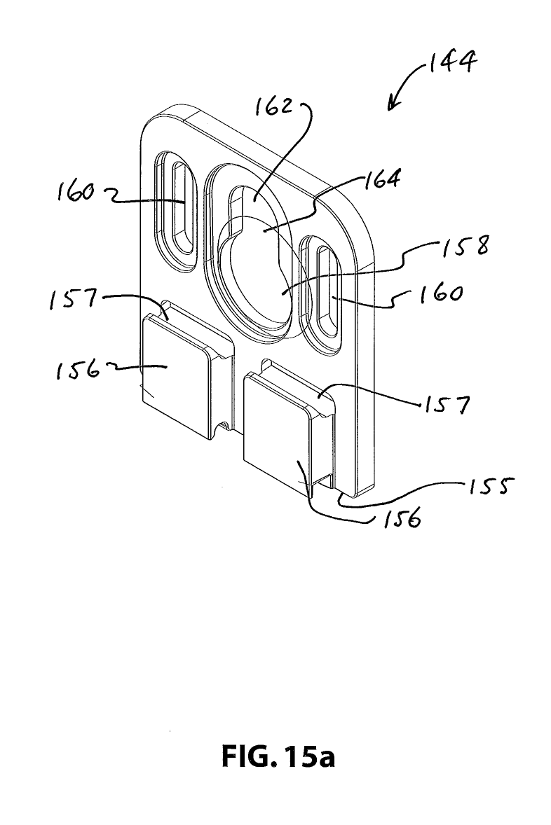

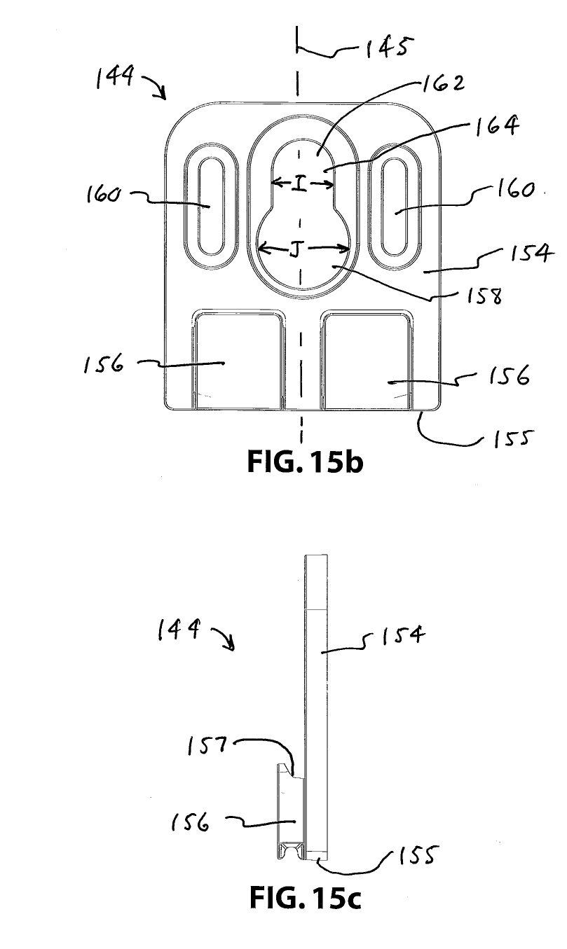

As shown in FIGS. 15a-c, the sled 144 has a substantially planar base portion 154 and two protruding ledges 156 at the lower end of the base portion 154. Each ledge 156 has a retention groove 157 on its top that slopes upward from the bottom 155 of the base portion 154 as it extends outward from the base portion 154. Extending through the base portion 154 is a stud hole 158 and two elongated apertures 160 on opposite sides of the stud hole 158. The elongated apertures 160 are essentially elongated oval-shaped openings to accept screws, nails, or other fasteners for securing the base portion 154 to a furniture panel, thereby allowing the sled 144 to move along a sled axis 145. Adjacent to the stud hole 158 is the capture slot 162. The capture slot 162 has a width I while the stud hole 158 has a width J, wherein J is greater than I.

The width J of the stud hole 158 is approximately equal to or slightly larger than the diameter F of the stud 142 so that the upper portion 152 of the stud 142 may fit through the stud hole 158. The diameter I of the capture slot 162 is approximately equal to and slightly larger than the diameter G of the groove 150 of the stud 142 so that the groove 150 of the stud 142 may fit into the capture slot 162.

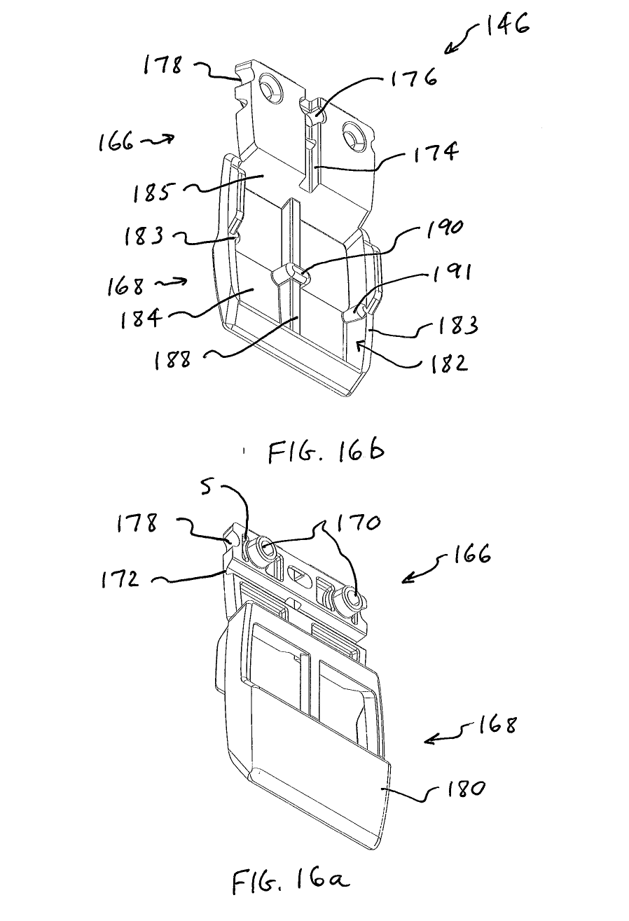

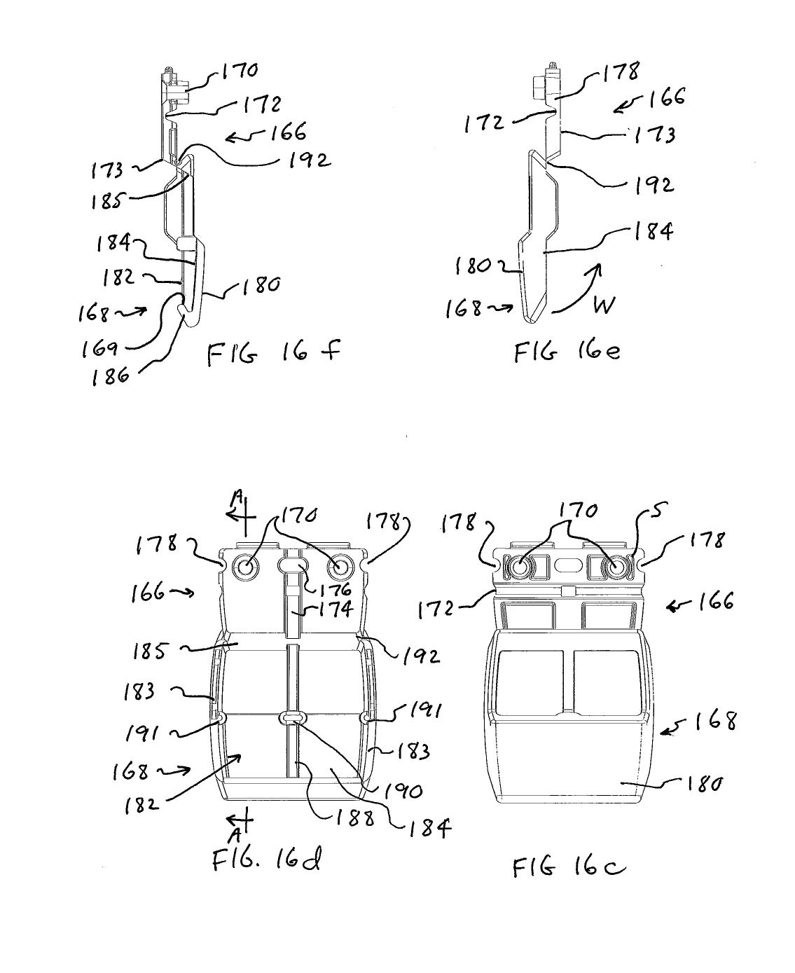

As shown in FIGS. 16a-f, the clasp 146 includes a base 166 and an engaging link 168. The clasp 146 may be made of any suitably resilient, yet flexible material such as plastic. The base 166 includes two holes 170 extending through the base 166, and also includes a first hinge 172. The first hinge 172 is defined by a reduced thickness segment of the base 166 so that it is flexible and the adjacent compression link 173 may pivot about the first hinge 172. As shown in FIGS. 16b and 16d, the base 166 has a channel 174 running between the holes 170. The channel 174 widens near the bottom of the base 166 to form an oval-shaped plug hole 176, then narrows to its original width as the channel 174 reaches the bottom of the base 166. On opposite ends of the base 166 and adjacent to the holes 170 are two plug cavities 178 defined by a concave semicircular absence of material.

The engaging link 168 of the clasp 146 has an outer side 180 with a gently sloped contour as shown in FIGS. 16a and 16e. The engaging link 168 also has an inner side 182 having a generally concave shape defined by an inside surface 184, side walls 183, a bottom wall 185, and a latch 186 having a locking face 169, all of which extend outwardly from the inside surface 184. A bar 188 protrudes from the inside surface 184 and extends from the latch 186 to the bottom wall 185. On the bar 188 is a central plug 190 extending outwardly and laterally from the bar 188. On the side walls 183 are side plugs 191 of generally semicylindrical shape extending from the side walls 183 inward toward the bar 188.

The bar 188 and central plug 190 are sized and configured to fit into the channel 174 and plug hole 176, respectively, on the base 166. Likewise, the side plugs 191 are sized and configured to fit into the plug cavities 178 on the base 166. The latch 186 is generally hook shaped (see FIG. 16f) and is sized and configured for the locking face 169 to engage with the retention grooves 157 of the ledges 156 on the sled 144. At the interface between the compression link 173 and the engaging link 168 is a second hinge 192 defined by a thin portion of material that allows the compression link 173 and the engaging link 168 to bend with respect to one another. The second hinge 192 is configured to allow the engaging link 168 to rotate in direction W (FIG. 16e) about the second hinge 192 until the inside surface 184 of the engaging link 168 makes contact and engages with the base 166. This motion acts to deform the compression link 173, such that in the locked position, the locking face 169 exerts a downward force on the sled 140.

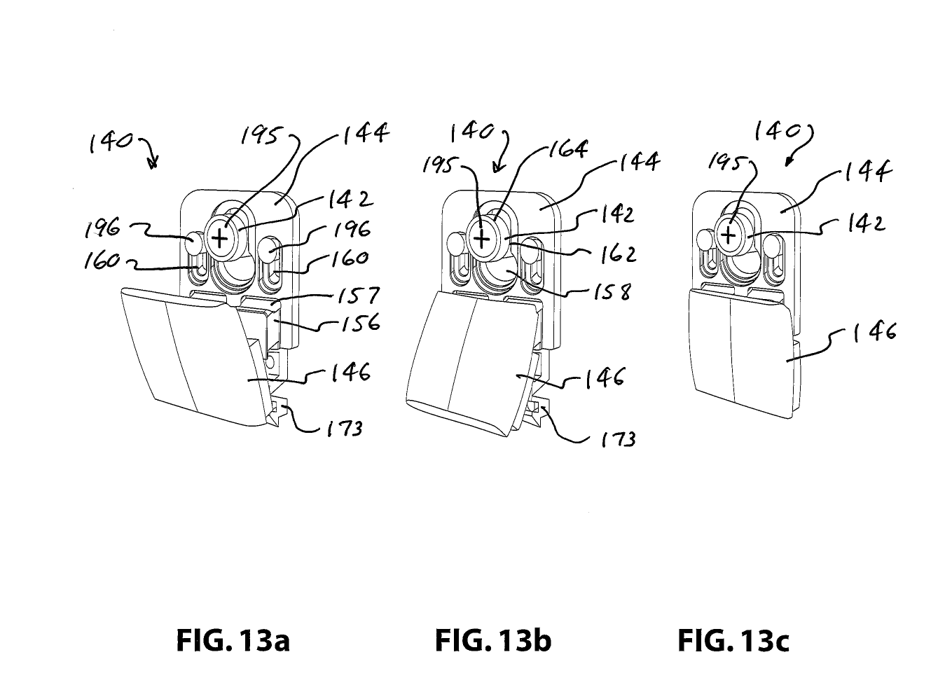

In use for assembling a piece of furniture, the stud 142, sled 144, and clasp 146 are attached to the furniture panels as follows. Referring to FIGS. 12a-d and 13a-c, the stud 142 may be attached to the end of a first furniture panel 193 by way of a screw, nail, or any other method known in the art. As shown in FIGS. 13a-c and 12a, a screw 195 may be inserted through the stud 142 and into the first furniture panel 193 to attach the stud 142. The stud 142 is sized and configured so that the lower portion 148 may fit into a hole within a second furniture panel 194, allowing the middle and upper portions 150, 152 of the stud 142 to extend through to the other side of the second furniture panel 194, as shown in FIG. 12. The sled 144 is slidably attached to the second furniture panel 194 by way of pins 196 extending through elongated apertures 160 (see FIG. 13a). The pins 196 are inserted tightly enough to hold the sled 144 firmly against the second furniture panel 194, but loosely enough to allow the sled 144 to slide up and down with respect to the pins 196. The pins 196 may be screws, nails, or any other suitable object to attach the sled 144 to the second furniture panel 194 in a mariner such that the sled 144 can slide up and down along the length of the elongated apertures 160 with respect to the pins 196. The clasp 146 is attached to the second furniture panel 194 via screws or nails through the holes 170 on the base 166 so that surface S (FIGS. 16a and 16c) of the base 166 is directly adjacent to the second furniture panel 194.

The general operation of the clasp connector system 140 involves the clasp 146 flexing and rotating to clasp the retention groove 157 of the ledge 156 of the sled 144 to lock the stud 142 in place. Once the stud 142 attached to the first furniture panel 193 is inserted through the second furniture panel 194 and through the lower portion 162 of the stud hole 158 on the sled 144 (which is aligned with the hole through the second furniture panel 194), the clasp connector system 140 appears as it does in FIG. 12b. Referring to FIGS. 12b and 16a-f, the clasp 146 can then be flexed about the first hinge 172 and second hinge 192 to appear as it is shown in FIG. 12b. The clasp 146 is continually lifted and folded until the latch 186 engages with the retention groove 157 on the ledge 156 of the sled 144, as shown in FIGS. 12c and 13b. The clasp 146 may then be pushed toward the second furniture panel 194, causing the clasp 146 to settle downward into the position shown in FIGS. 12d and 13c. As the clasp 146 settles in this manner, the latch 186 pulls downward on the ledges 156 on the sled 144, causing the sled 144 to slide downward. This downward slide of the sled 144 causes the stud hole 158 to move with respect to the stud 142, such that the middle portion 150 of the stud 142 moves into the upper portion 164 of the stud hole 158. When the clasp 146 is fully settled as shown in FIGS. 12d and 13c, referring now to FIG. 16d, the bar 188, central plug 190, and side plugs 191 have been inserted into the channel 174, plug hole 176, and plug cavities 178, respectively. In this clasped configuration, the stud 142 cannot be removed from the sled 144 because of the respective diameters of the stud hole and the stud as described above. Therefore, the first furniture panel 193 and second furniture panel 194 are securely attached to each other.

Further, it will be readily appreciated by those skilled in the art that modifications may be made to the invention without departing from the concepts disclosed in the foregoing description. Accordingly, the particular embodiments described in detail herein are illustrative only and are not limited to the scope of the invention, which is to be given the full breadth of the appended claims and any and all equivalents thereof.

The invention claimed is:

1. A system for assembling a piece of furniture made of furniture panels comprising at least two labels, each affixed to separate furniture panels intended to be attached to one another, wherein each label has identifying indicia identifying the panel and directional indicia indicating the identity of the adjacent panel and the relative orientation of the adjacent panel when attached.

2. The system according to claim 1, wherein the identifying indicia is positioned at the core of the label.

3. The system according to claim 2, wherein the identifying indicia may be comprised of letters, numbers and symbols.

4. The system according to claim 1, wherein the directional indicia is positioned about the periphery of the label.

5. The system according to claim 4, wherein the directional indicia may be comprised of letters, numbers and symbols.

6. The system according to claim 5, wherein the directional indicia further include arrows indicating the direction of the adjacent panel.

7. The system according to claim 1, wherein each label is made up of paint applied to a panel.

8. The system according to claim 1, wherein each label is made up of a sticker adhesively secured to the panel.

9. A connector for securing together two panels of a piece of furniture wherein one panel lies along a first plane and the second panel lies along a second plane which is orthogonal to the first plane, the connector comprising:
a) a mounting plate adapted to be secured to the first panel; wherein the mounting plate has a knob extending therefrom, wherein the knob has a shank with a length along the knob axis and an associated width;
b) an anchoring plate adapted to be secured to the second panel, wherein the anchoring plate has a base and a connecting portion made up of a cantilevered element extending from the base in a generally orthogonal direction defining a cantilevered plane,
i) wherein the cantilevered element forms a slot,
ii) wherein the width of the slot at an open end and at a closed end is greater than the width of the shank of the knob,
iii) wherein between the ends the slot has a reduced width less than the knob shank width,
iv) wherein in the region of the reduced width the cantilevered element includes a secondary slot to form a resilient locking tab, and
v) wherein the closed end of the slot generally conforms to the shape of the shank of the knob and the tip of the resilient locking tab extends within the slot to define a width equal to or less than the knob shank width such that when the knob moves from the open end to the closed end of the slot, the resilient tab is first depressed and then released to engage and retain the shank of the knob within the closed end of the slot.

10. The connector in accordance with claim 9, wherein the knob further includes an enlarged end on the shank having a width greater than both the width of the shank and the width of the slot at the closed end, thereby defining a shank length to the enlarged end and wherein the connecting portion of the anchoring plate has a thickness approximately equal to or less than the shank length such that the knob when retained in the closed end of the slot is also retained in a direction along the axis of the knob shank.

11. The connector in accordance with claim 9, wherein the closed end of the slot generally conforms to the contour of the shank of the knob and the shape of the tip adjacent to the closed end generally follows the contour of the knob shank.

12. The connector in accordance with claim 9, wherein the mounting plate and the anchoring plate have holes extending therethrough to accept fasteners for attachment to the panels.

13. The connector in accordance with claim 12, further including fasteners extending through the holes.

14. The connector in accordance with claim 9, further including the first and second furniture panels to which the mounting plate and the anchoring plate are intended to be secured.

15. A connector for securing together two panels of a piece of furniture wherein one panel lies along a first plane and the second panel lies along a second plane which is orthogonal to the first plane, the connector comprising:
a) a male component having
i) a base with opposing ends and a generally planar face;
ii) a T-rail between the ends of the base, wherein the T-rail is defined by a narrow portion connecting a wider portion, wherein the wider portion of the T-rail lies along a plane perpendicular to the base of the male component and the shank of the T-rail lies along an axis parallel to the base of the male component, and
iii) a stabilizing surface adjacent to the T-rail and generally parallel to the base, and
b) a female component having
i) a base with opposing ends and a generally planar face;
ii) a T-slot between the ends of the base, wherein the wide portion of the T-slot lies along a plane parallel to the base of the female portion and the narrow portion of the T-slot lies along a plane perpendicular to the base, and
iii) a stabilizing surface mounted adjacent to the T-slot and generally parallel to the base;
c) wherein the T-slot of the female component is adapted to receive the T-rail of the male component and the stabilizing surfaces are adapted to abut with one another to provide lateral stability to the paired configuration;
d) a resiliently deflectable tab mounted along the stabilizing surface of one of either the male component or the female component
e) a notch extending within the other of the stabilizing surface of the male component or the female component, wherein the deflectable tab is adapted to be received by the notch, when the two components are mounted, thereby retaining the male component and the female component in the mounted position.

16. The connector in accordance with claim 15, wherein the contours of the stabilizing surfaces of the male component and the stabilizing surface of the female component conform to one another.

17. The connector in accordance with claim 16, wherein the stabilizing surface of the male component and the stabilizing surface of the female component are planar.

18. The connector in accordance with claim 17, wherein the resiliently deflectable tab is a convexly curved portion with steep sides and has material with a relatively high spring constant such that the tab engages the notch with an audible click.

19. The connector in accordance with claim 15, further including the first and second furniture panels.

20. A snap hinge connector for securing two furniture panels at a right angle relative to one another, wherein the hinge connector is comprised of:
a) a hinge pivotable along a hinge axis
b) a male side connected to the hinge, wherein the male side has a divider with a recess on one side and a mating face on the other side;
i) wherein the male side recess along a recess plane is adapted to accept a furniture panel
ii) wherein the mating face has resilient tabs extending therefrom, wherein the tabs have a hook configuration with an engaging surface on the interior of the hook,
c) a female side connected to the hinge, wherein the female side has a divider with a recess on one side and a mating face on the other side;
i) wherein the female side recess along a recess plane is adapted to accept a furniture panel,
ii) wherein the mating face has slots extending therein and have rear surfaces adapted to accept the engaging surface,
d) wherein the male mating faces and the female mating surfaces are aligned with one another and come together when the sides are pivoted about the hinge such that the hook engaging surfaces align with the rear surface of the slots.

21. The snap hinge in accordance with claim 20, wherein the slots have a wall with a beveled surface and the resilient tabs are located proximate to these walls so that the tabs may be resiliently deflected by the beveled surfaces prior to locking within the slot.

22. The snap hinge connector in accordance with claim 20, wherein the resilient tabs deflect in a direction parallel to the hinge axis and the slot rear surfaces are parallel with the hinge axis to accept and engage the tabs.

23. The snap hinge connector in accordance with claim 22, wherein there are multiple tab/slot pairs along the length of the hinge.

24. The snap hinge connector in accordance with claim 23, wherein there are two tabs associated with each slot.

25. The snap hinge connector in accordance with claim 22, wherein mating faces of each hinge forms an angle of 45 degrees with the respective recess plane such that when the mating faces contact one another, the recess planes form an angle of 90 degrees with one another.

26. The snap hinge connector in accordance with claim 20, wherein one of the male side or the female side has a mound protruding therefrom and the other of the male side and the female side has a conforming cavity for support.

27. The snap hinge connector in accordance with claim 20, wherein the mounds and conforming cavities surround the resilient tabs and the slots.

28. The snap hinge connector in accordance with claim 20, wherein the tabs have straight walls such that when the tabs pass the cavity, they abruptly expand and create a clicking sound.

29. The snap hinge connector in accordance with claim 20, wherein the hinge is comprised of a narrow strip of flexible material between the male side and the female side.

30. The snap hinge connector in accordance with claim 1, further including furniture panels connected to each of the male side and the female side.

31. A clasp connector for securing together two panels of a piece of furniture wherein one panel lies along a first plane and the second panel lies along a second plane which is perpendicular to the first plane, the connector comprising:
a) a stud attached to a first panel, wherein the stud has a shank with a shank diameter and a groove therein with a groove diameter;
b) a sled attached to the second panel and movable along a sled axis, wherein the sled along the sled axis has a stud hole adapted to receive the stud shank and an adjacent capture slot having a width less than the width of the stud shank but greater than the width of the groove such that with the stud in the stud hole, when the sled is moved along the sled axis, the capture slot engages the groove and captures the stud,
c) a clasp having a base secured to the second panel proximate to the sled, wherein the clasp has an locking face which acts against a retention groove in a protruding ledge on the sled to maintain the sled in the locked position.

32. The clasp connector in accordance with claim 31, wherein the clasp has a base with a compression link pivotally mounted thereto and an engaging link pivotally attached to the compression link, wherein the engaging link has a locking face that translates along the sled axis by pivoting the compression link and the engaging link, wherein the locking face may move between an un-locked position and a locked position.

33. The clasp connector in accordance with claim 31, wherein the compression link and the engaging link are sized such that in the locked position the locking face rests beyond the retention groove such that when the locking face engages the retention groove there is a compressive retention force imparted to the locking face.

34. The clasp connector in accordance with claim 33, wherein the groove in the stud is v-shaped and the capture slot has a conforming v-shape to capture the stud shank.

35. The clasp connector in accordance with claim 31, further including within the clasp a plug extending from the engaging link and a plug hole recessed within the base, wherein the plug and the plug hole are aligned and mated when the clasp is in the locked position to retain the engaging link within the base.

36. The clasp connector in accordance with claim 31, wherein the sled is retained slidably against the panel by elongated apertures extending along the sled and fasteners extending through the elongated apertures into the panel, wherein the apertures are elongated along the sled axis.

37. The clasp connector in accordance with claim 31, further including the furniture panels to which the connector is applied.
